(19) United States
(12) Patent Application Publication
(10) Pub. No.: US 2020/0065232 A1
(43) Pub. Date: Feb. 27, 2020

(54) METHOD FILTERING APPARATUS, METHOD FILTERING PROCEDURE AND METHOD FILTERING SYSTEM

(71) Applicant: Shimadzu Corporation, Kyoto (JP)

(72) Inventor: Gregory KING, Kyoto (JP)

(73) Assignee: Shimadzu Corporation, Kyoto (JP)

(21) Appl. No.: 16/546,544

(22) Filed: Aug. 21, 2019

(30) Foreign Application Priority Data
Aug. 22, 2018 (JP) 2018-155791

(51) Int. Cl. G06F 11/36; G06F 8/61

(52) U.S. Cl. CPC G06F 11/3668; G06F 8/61

(57) ABSTRACT

Element information unique to each device element included in an analysis device is acquired by a device information acquirer from the analysis device, and method file information relating to a plurality of method files and device specifying information for specifying an analysis device that is compatible with each method file are acquired by a provision system information acquirer from a provision system. A method file that is usable in the analysis device is determined by a determiner from among the plurality of method files provided by the provision system based on the acquired element information, the acquired method file information and the acquired device specifying information. A result of determination is output by an outputter.

### FIELD

The present invention relates to a method filtering apparatus, a method filtering procedure and a method filtering system for filtering a method file that is compatible with an analysis device.

### BACKGROUND

An application file that is referred to as a method file is installed in an analysis device such as a mass spectrometer or a gas chromatographic device. The method file is an application file for controlling an analysis device, collecting analysis data and storing an analysis data processing condition, a condition for outputting a report and the like and can be obtained by online purchase, for example. The analysis device operates based on the method file, whereby analysis data about a sample that is set in the analysis device is acquired and output.

### SUMMARY

When a method file is obtained by online purchase or the like, a user is required to select a method file that is compatible with a type of his or her own analysis device from among various provided method files. Here, the analysis device includes a large number of device elements such as various columns, various detectors, various model numbers and various pre-processing devices, etc. The number of types of analysis devices exceeds several hundred depending on the combinations of these device elements. Therefore, it is not easy for an unskilled user to select an appropriate method file. Thus, conventionally, unskilled users used to make inquiries to the providers of method files in order to select appropriate method files. In this case, users' workloads are large.

JP 2001-188840 A describes a merchandise system that enables online purchase while reducing a user's workload. In this merchandise system, the user designates a product (an ink cartridge, for example), which the user wishes to purchase. In this case, the user's information processing apparatus transmits attributes of the product and a model ID (identifier) for specifying the model of the user's printer to the contents provider's device. The contents provider's device extracts a product code for uniquely specifying the product based on the attributes of the product and the model ID by searching in a database, and presents the extracted product code to the user.

Unlike a printer or the like, however, the analysis device is customized by a change of the device elements according to an intended use. In this case, a method file that used to be compatible may become incompatible. In contrast, a method file that used to be incompatible may become compatible. In this manner, a method file that is compatible with the analysis device changes dynamically, so that it is difficult to select a method file that is compatible with any analysis device using the merchandise system described in JP 2001-188840 A.

An object of the present invention is to provide a method filtering apparatus, a method filtering procedure and a method filtering system that facilitate acquisition of a method file that is usable in any analysis device.

(1) A method filtering apparatus according to one aspect of the present invention that determines a method file that is usable in a predetermined analysis device from among a plurality of method files provided by a provision system, wherein the analysis device includes a plurality of device elements and being configured to be capable of changing the device elements, and the method filtering apparatus includes a device information acquirer that acquires element information relating to the device elements from the analysis device, a provision system information acquirer that acquires method file information relating to the plurality of method files and device specifying information for specifying an analysis device that is compatible with each method file from the provision system, a determiner that determines a method file that is usable in the analysis device from among the plurality of method files provided by the provision system based on the element information acquired by the device information acquirer, and the method file information and the device specifying information acquired by the provision system information acquirer, and an outputter that outputs a result of determination by the determiner.

In this method filtering apparatus, the element information unique to each device element included in the analysis device is acquired from the analysis device, and the method file information relating to the plurality of method files and the device specifying information for specifying the analysis device that is compatible with each method file are acquired from the provision system. The method file that is usable in the analysis device is determined from among the plurality of method files provided by the provision system based on the acquired element information, the acquired method file information and the acquired device specifying information, and a result of determination is output.

With this configuration, even when the device element of the analysis device is changed, the method file that is usable in the analysis device, the device element of which has been changed, is determined based on the method file information and the device specifying information. Therefore, even when not being skilled at handling the analysis device, the user can easily identify the method file that is usable in the analysis device by viewing a result of determination. Thus, the method file that is usable in any analysis device can be easily acquired.

(2) The method filtering apparatus may further include a file requester that, based on an instruction given by a user, requests the provision system for any method file from among one or more method files that have been determined by the determiner as being usable in the analysis device, and a file acquirer that acquires the method file requested by the file requester from the provision system. In this case, the method file that is usable in any analysis device can be more easily acquired.

(3) Device specifying information may further include fixture information indicating types of reagents, expendables or accessory devices to be used at a time of execution of each method file, and the outputter, based on the fixture information, may further output information about the types of the reagents, expendables or accessory devices to be used at the time of execution of each method file that has been determined by the determiner as being usable in the analysis device. In this case, the user can easily identify the information about the types of the reagents, expendables or accessory devices to be used at the time of execution of the desired method file.

(4) The fixture information may further include information indicating countries of origin of the reagents, expendables or accessory devices, and the outputter, based on the fixture information, may further output the information about the countries of origin of the reagents, expendables or accessory devices to be used at the time of execution of each method file that has been determined by the determiner as being compatible with the analysis device. In this case, the countries of origin of the reagents, expendables or accessory devices can be easily identified. Even when the countries of origin are restricted, this facilitates acquisition of the reagents, expendables or accessory devices from the countries of origin.

(5) The outputter may include a display controller that allows a display unit to display a result of determination by the determiner. In this case, the user can easily view the result of determination in the display unit.

(6) The outputter may include a storage controller that allows a storage to store a result of determination by the determiner. In this case, the user can easily identify or acquire a method file that is compatible with the analysis device at a desired time using the stored result of determination.

(7) A method filtering system according to another aspect of the present invention includes an analysis device that includes a plurality of device elements and is configured to be capable of changing the device elements, a provision system that provides a plurality of method files and provides device specifying information for specifying an analysis device that is compatible with each method file, and the method filtering apparatus according to one aspect of the present invention that determines a method file that is usable in the analysis device from among the plurality of method files provided by the provision system.

In this method filtering system, the method file that is usable in the analysis device is determined by the above-mentioned method filtering apparatus from among the plurality of method files provided by the provision system. Therefore, even when not being skilled at handling the analysis device, the user can easily identify the method file that is usable in the analysis device by viewing a result of determination. Thus, the method file that is usable in any analysis device can be easily acquired.

(8) A method filtering procedure according to yet another aspect of the present invention for determining a method file that is usable in a predetermined analysis device from among a plurality of method files provided by a provision system, wherein the analysis device includes a plurality of device elements and being configured to be capable of changing the device elements, and the method filtering procedure includes acquiring element information relating to the device elements from the analysis device, acquiring method file information relating to the plurality of method files and device specifying information for specifying an analysis device that is compatible with each method file from the provision system, determining a method file that is usable in the analysis device from among the plurality of method files provided by the provision system based on the acquired element information, the acquired method file information and the acquired device specifying information, and outputting a result of determination.

With this method filtering procedure, even when not being skilled at handling the analysis device, the user can easily identify the method file that is usable in the analysis device by viewing a result of determination. Thus, the method file that is usable in any analysis device can be easily acquired.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a diagram showing a configuration of a method filtering system according to one embodiment of the present invention;

FIG. 2 is a diagram showing a configuration of a method filtering apparatus of FIG. 1;

FIG. 3 is a diagram for explaining method file information and device specifying information;

FIG. 4 is a diagram showing one example of a determination result screen that is displayed in a display unit;

FIG. 5 is a diagram showing one example of an option screen displayed in the display unit; and

FIG. 6 is a flow chart showing the algorithm of a method filtering process executed by a method filtering program.

### DETAILED DESCRIPTION

### (1) Configuration of Method Filtering System

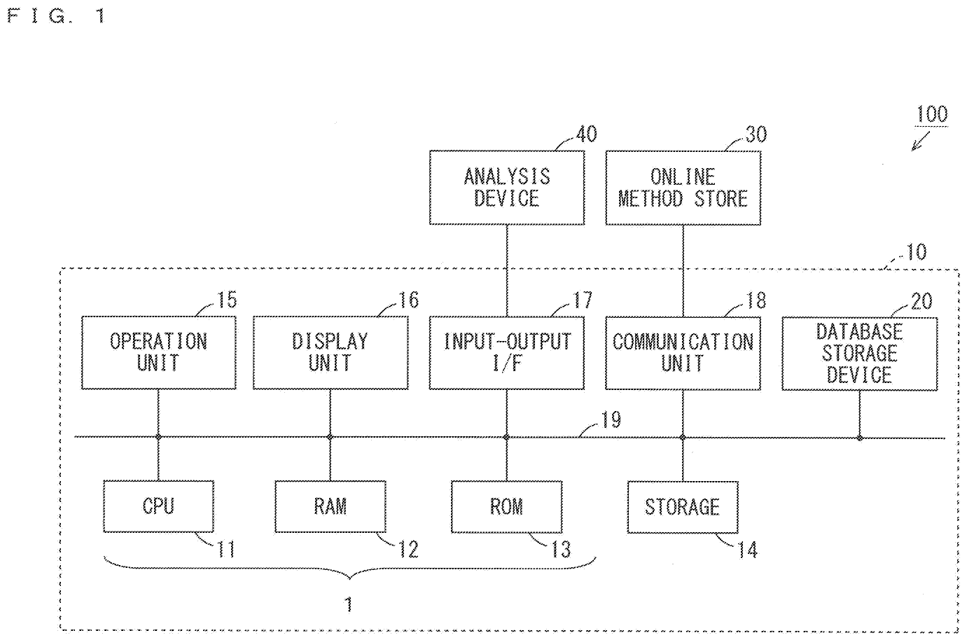

A method filtering apparatus, a method filtering system including the method filtering apparatus and a method filtering procedure according to embodiments of the present invention will be described below in detail with reference to drawings. FIG. 1 is a diagram showing the configuration of the method filtering system according to one embodiment of the present invention. As shown in FIG. 1, the method filtering system 100 includes a processing device 10, an online method store 30 and an analysis device 40.

The processing device 10 is constituted by a CPU (Central Processing Unit) 11, a RAM (Random Access Memory) 12, a ROM (Read Only Memory) 13, a storage 14, an operation unit 15, a display unit 16 and an input-output I/F (interface) 17, a communication unit 18, a bus 19 and a database storage device 20. The CPU 11, the RAM 12, the ROM 13, the storage 14, the operation unit 15, the display unit 16, the input-output I/F 17, the communication unit 18 and the database storage device 20 are connected to the bus 19. The CPU 11, the RAM 12 and the ROM 13 constitute the method filtering apparatus 1.

The RAM 12 is used as a work area for the CPU 11. A system program is stored in the ROM 13. The storage 14 includes a storage medium such as a hard disc or a semiconductor memory, and stores a method filtering program. The CPU 11 executes the method filtering program stored in the storage 14 on the RAM 12, so that a method filtering process, described below, is performed.

The operation unit 15 is an input device such as a keyboard, a mouse or a touch panel. The display unit 16 is a display device such as a liquid crystal display device. A user can give various instructions to the method filtering apparatus 1 using the operation unit 15. The display unit 16 can display the result that is output by the method filtering apparatus 1. The input-output I/F 17 is connected to the analysis device 40.

The communication unit 18 is an interface for connecting the method filtering apparatus 1 to the Internet. The method filtering apparatus 1 communicates with the online method store 30 connected to the Internet via the communication unit 18. The database storage device 20 includes a mass storage device such as a server, and stores a large number of method files and information about the method files in advance. A method file is an application file for controlling the analysis device 40, collecting analysis data and storing an analysis data processing condition and a condition for outputting a report, etc. The information relating to the method file includes the name or unique identifier of the method file, for example.

The online method store 30 sells various method files via the Internet. The user can acquire a desired method file from the database storage device 20 or the online method store 30 and install the desired method file in the analysis device 40. The analysis device 40 is a mass spectrometer, a gas chromatographic device or a liquid chromatographic device, for example, and acquires and outputs analysis data about a sample based on the installed method file.

The analysis device 40 includes a plurality of device elements such as a column, a detector, a model number, a pre-processing device and so on. The user can customize the analysis device 40 by changing the plurality of device elements according to the intended use. Changing the plurality of device elements includes replacing at least part of the plurality of device elements with another device element, removing part of the plurality of device elements or adding another device element to the plurality of device elements. In this case, the method files that are usable in the analysis device 40 change dynamically according to the combinations of the device elements included in the analysis device 40.

The method filtering apparatus 1 determines one or more method files that are usable in the analysis device 40 from among the method files stored in the database storage device 20 or the method files being sold by the online method store 30. Further, the method filtering apparatus 1 presents the method files that are determined as being usable in the analysis device 40 to the user. The configuration of the method filtering apparatus 1 will be described below.

### (2) Configuration of Method Filtering Apparatus

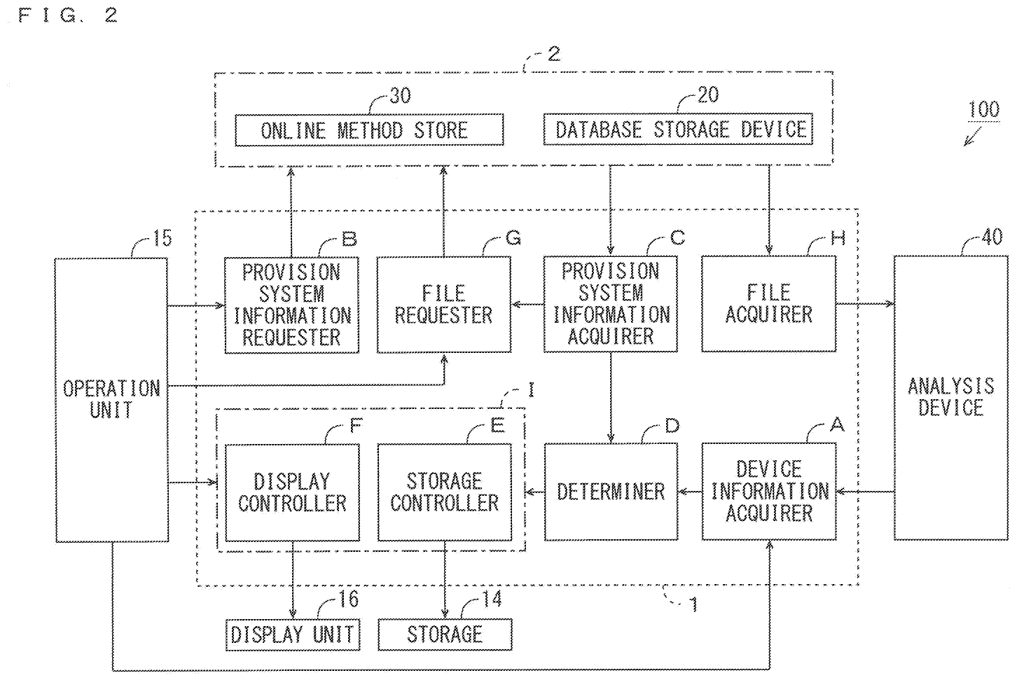

FIG. 2 is a diagram showing the configuration of the method filtering apparatus 1 of FIG. 1. As shown in FIG. 2, the method filtering apparatus 1 includes a device information acquirer A, a provision system information requester B, a provision system information acquirer C, a determiner D, a storage controller E, a display controller F, a file requester G and a file acquirer H as functions. The storage controller E and the display controller F constitute an outputter I.

The CPU 11 of FIG. 1 executes the method filtering program stored in the storage 14, so that the functions of the method filtering apparatus 1 are realized. Part or all of the functions of the method filtering apparatus 1 may be realized by hardware such as an electronic circuit.

Unique element information provided to each device element is stored in the analysis device 40. The device information acquirer A automatically acquires element information from the analysis device 40 at the time of activation of the method filtering apparatus 1. The device information acquirer A may acquire or update the element information from the analysis device 40 not only at the time of activation based on a user's operation of the operation unit 15.

The database storage device 20 owns the device specifying information indicating one or more device elements, which the analysis device is to include in order to be compatible with the method file, with respect to each stored method file. Similarly, the online method store 30 owns the device specifying information indicating one or more device elements, which the analysis device is to include in order to be compatible with the method file, with respect to each method file being sold by the online method store 30. Details of the device specifying information will be described below. The provision system information requester B requests the database storage device 20 or the online method store 30 for the method file information relating to a plurality of method files and the device specifying information for specifying the analysis device that is compatible with each method file based on a user's operation of the operation unit 15.

In the following description, the data base storage device 20 or the online method store 30 is referred to as a provision system 2. The provision system 2 gives the device specifying information owned by the provision system 2 to the method filtering apparatus 1 in response to a request from the method filtering apparatus 1. The provision system information acquirer C acquires the method file information and the device specifying information from the provision system 2. The determiner D determines a method file that is usable in the analysis device 40 based on the element information acquired by the device information acquirer A, and the method file information and the device specifying information that are acquired by the provision system information acquirer C.

The storage controller E allows the storage 14 to store the information indicating one or more method files, which the determiner D has determined as being usable in the analysis device 40. The user can identify or acquire a method file that is usable in the analysis device 40 at a desired time using a result of determination stored in the storage 14. The display controller F allows the display unit 16 to display the information (names and contents) and the like about the one or more method files, which the determiner D has determined as being usable in the analysis device 40. The user can select a desired method file by operating the operation unit 15 while viewing the information about the one or more method files displayed in the display unit 16.

The file requester G requests the provision system 2 for the method file selected by the user. The provision system 2 gives the requested method file to the method filtering apparatus 1 in response to a request from the method filtering apparatus 1. The file acquirer H acquires the method file requested by the file requester G from the provision system 2. Further, the file acquirer H installs the acquired method file in the analysis device 40.

### (3) Specific Example of Operation of Method Filtering Apparatus

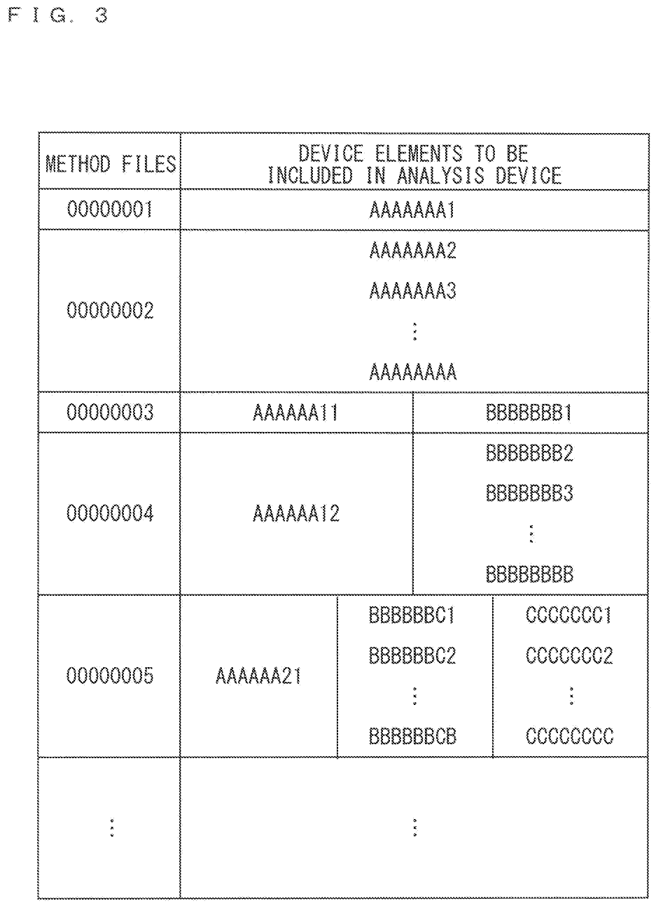

FIG. 3 is a diagram for explaining the method file information and the device specifying information. In the following description, a method file provided with a unique identifier “oooo” such as “00000001” is referred to as a method file “oooo.” A device element provided with a unique identifier “Δ Δ Δ Δ” such as “AAAAAAA1” is referred to as a device element “Δ Δ Δ Δ”.

In the example of FIG. 3, the method file “00000001” is compatible with the analysis device 40 including the device element “AAAAAAA1.” A method file “00000002” is compatible with the analysis device 40 including any of device elements “AAAAAAA2,” “AAAAAAA3,” . . . , “AAAAAAAA.” A method file “00000003” is compatible with the analysis device 40 including a device element “AAAAAA11” and a device element “BBBBBBB1.”

A method file “00000004” is compatible with the analysis device 40 including a device element “AAAAAA12” and any of device elements “BBBBBBB2,” “BBBBBBB3,” . . . , “BBBBBBBB.” The method file “00000005” is compatible with the analysis device 40 including a device element “AAAAAA21,” any of device elements “BBBBBBC1,” “BBBBBBC2,” . . . , “BBBBBBCB” and any of the device elements “CCCCCCC1,” “CCCCCCO2,” . . . , “CCCCCCCC.”

In this manner, the device specifying information indicates the device element that is compatible with each method file or a combination of device elements that is compatible with each method file. Thus, even when a device element of the analysis device 40 is changed due to customization of the analysis device 40 by the user, the determiner D can determine a method file that is usable in the customized analysis device 40. Thereafter, the display controller F allows the display unit 16 to display a determination result screen indicating a result of determination.

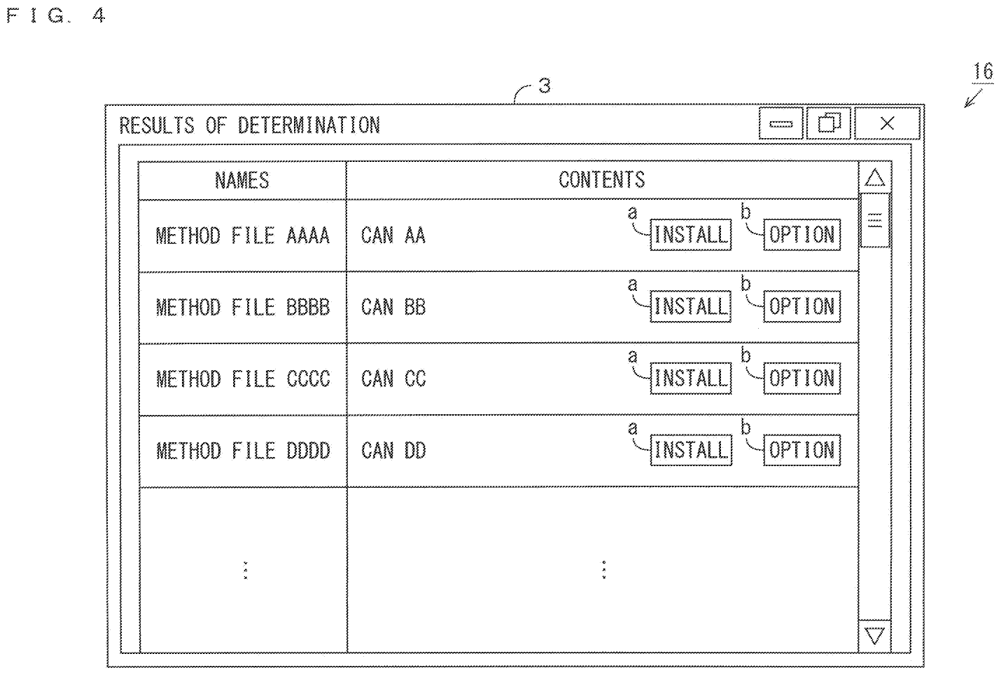

FIG. 4 is a diagram showing one example of the determination result screen that is displayed in the display unit 16. As shown in FIG. 4, the names of one or more method files that are determined as being usable in the analysis device 40 and the corresponding contents of the method files are displayed in the determination result screen 3. In the example of FIG. 4, the name of a method file displayed in the determination result screen 3 is “method file AAAA” or the like, and the contents of the method file displayed in the determination result screen 3 is “can AA” or the like. It is possible to allow the names and contents of the other method files to be displayed in the determination result screen 3 by operating a scroll bar in the determination result screen 3.

In a display section for the contents corresponding to the name of each method file, an install button ‘a’ and an option button ‘b’ are displayed as well as the contents of the method file. The user can acquire the method file from the provision system 2 and install the method file in the analysis device 40 by operating the install button ‘a’ corresponding to a desired method file using the operation unit 15.

When a method file is acquired from the online method store 30, the display in the display unit 16 changes to the screen for confirmation of a payment amount, a payment method and the like for the method file by an operation of the install button ‘a.’ After a predetermined input operation is completed in the screen, the method file is installed in the analysis device 40.

The device specifying information includes the fixture information indicating the types of fixtures such as reagents, expendables or accessory devices to be used at the time of execution of each method file, and countries of origin of the fixtures. The expendables includes a filament of an electron beam source, for example. The accessory devices include a cell into which a sample is injected, for example. When finding out more information about the fixtures to be used at the time of execution of a desired method file, the user operates the option button ‘b’ corresponding to the method file using the operation unit 15. In this case, the display controller F allows the display unit 16 to display an option screen indicating the information about the fixtures based on the fixture information.

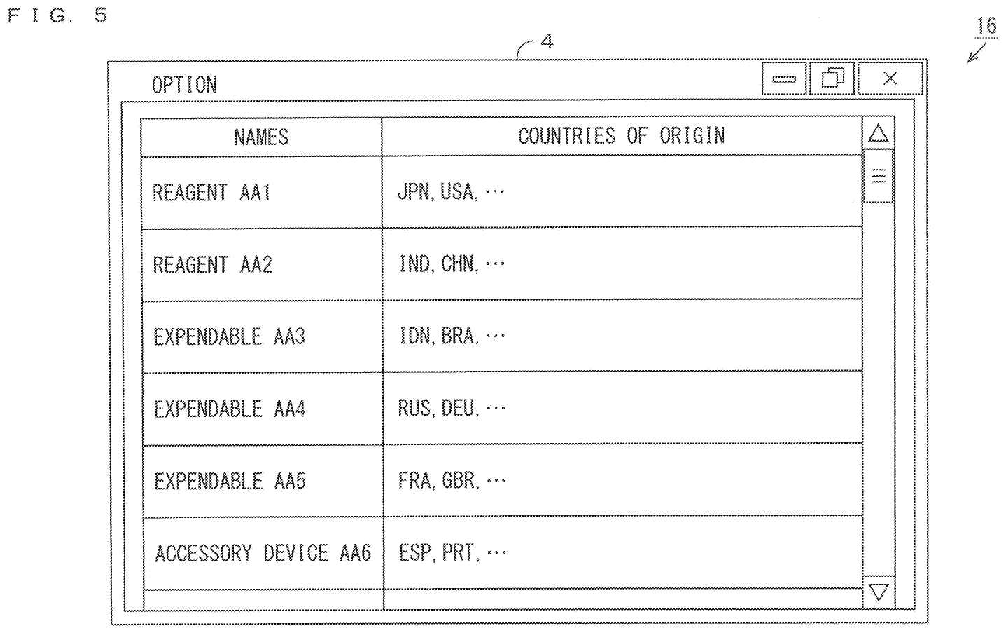

FIG. 5 is a diagram showing one example of the option screen displayed in the display unit 16. As shown in FIG. 5, the names of the fixtures to be used at the time of execution of a specific method file are shown. In the example of FIG. 5, the names of the fixtures displayed in an option screen 4 are “reagent AA1,” “expendable AA3,” “accessory device AA6” and the like. It is possible to allow the names of the other fixtures to be displayed in the option screen 4 by operating a scroll bar in the option screen 4.

When the countries of origin of the fixtures are restricted, it may be difficult to obtain specific fixtures in specific countries. As such, the name of the country of origin of each fixture is displayed to correspond to the name of the fixture in the option screen 4 based on the fixture information. The user can easily obtain a desired fixture from the country by identifying the name of the country of origin of the desired fixture.

### (4) Method Filtering Process

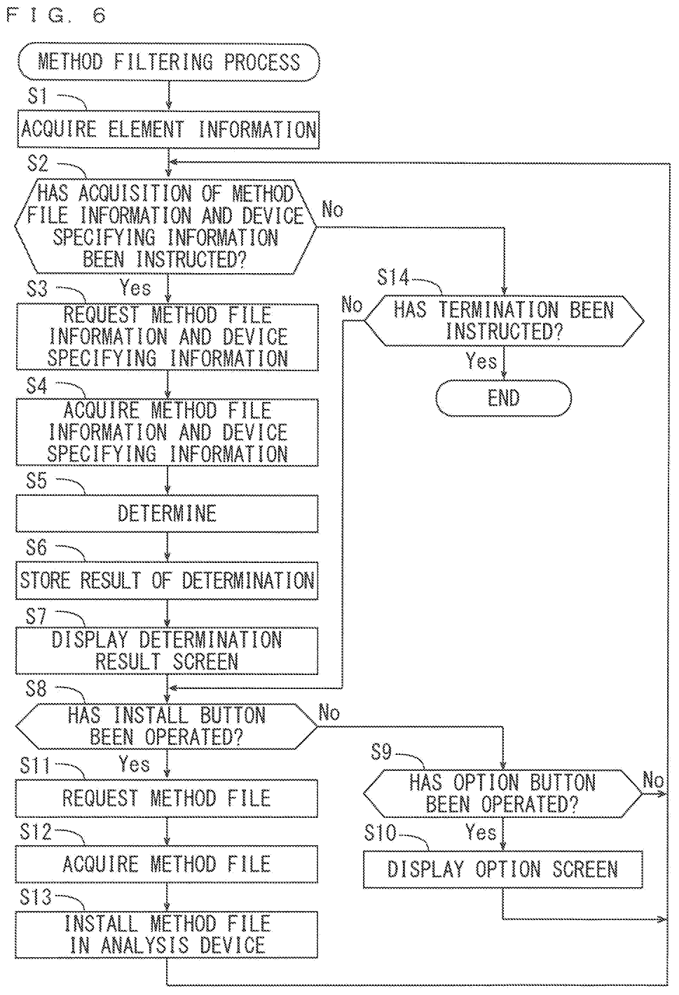

FIG. 6 is a flow chart showing the algorithm of the method filtering process executed by the method filtering program. In the present embodiment, the method filtering process is automatically started at the time of activation of the method filtering apparatus 1. The method filtering process may start not only at the time of activation of the method filtering apparatus 1 but also based on a user's operation of the operation unit 15. When the method filtering process starts, the device information acquirer A acquires the element information from the analysis device 40 (step S1).

Next, the provision system information requester B determines whether acquisition of the method file information and the device specifying information have been instructed (step S2). The user can give an instruction to acquire the method file information and the device specifying information by operating the operation unit 15. When the acquisition of the method file information and the device specifying information is instructed, the provision system information requester B requests the provision system 2 for the method file information and the device specifying information (step S3). The provision system information acquirer C acquires the method file information and the device specifying information requested in the step S3 from the provision system 2 (step S4).

The determiner D determines a method file that is usable in the analysis device 40 based on the element information acquired in the step S1, and the method file information and the device specifying information acquired in the step S4 (step S5). The storage controller E allows the storage 14 to store the information indicating the result of determination of the step S5 (step S6). The display controller F allows the display unit 16 to display the determination result screen 3 (see FIG. 4) indicating the result of determination of the step S5 (step S7).

The file requester G determines whether any install button ‘a’ has been operated in the determination result screen 3 displayed in the step S7 (step S8). When desiring to acquire any method file in the determination result screen 3, the user operates the install button ‘a’ corresponding to the method file.

When no install button ‘a’ is operated in the step S8, the file requester G determines whether any option button ‘b’ has been operated in the determination result screen 3 displayed in the step S7 (step S9). When finding out more information about the fixtures to be used at the time of execution of any method file in the determination result screen 3, the user operates the option button ‘b’ corresponding to the method file.

When no option button ‘b’ is operated in the step S9, the file requester G returns to the step S2. When any option button ‘b’ is operated, the display controller F allows the display unit 16 to display the option screen 4 (see FIG. 5) based on the device specifying information acquired in the step S4 (step S10). Thereafter, the display controller F returns to the step S2.

When any install button ‘a’ is operated in the step S8, the file requester G requests the provision system 2 for the method file corresponding to the operated install button ‘a’ (step S11). The file acquirer H acquires the method file requested in the step S11 from the provision system 2 (step S12). Further, the file acquirer H installs the method file acquired in the step S12 in the analysis device 40 (step S13). Thereafter, the file acquirer H returns to the step S2.

When acquisition of the method file information and the device specifying information is not instructed in the step S2, the provision system information requester B determines whether termination of the method filtering process has been instructed (step S14). The user can give an instruction to terminate the method filtering process by operating the operation unit 15.

When the termination of the method filtering process is not instructed in the step S14, the provision system information requester B proceeds to the step S8. When the provision system information requester B proceeds to the step S8 with no instruction to acquire the method file information and the device specifying information given, the determination result screen 3 is not displayed in the display unit 16. Therefore, the install button ‘a’ is not operated in the step S8. The option button ‘b’ is not operated in the step S9, either. When termination of the method filtering process is instructed in the step S14, the provision system information requester B terminates the method filtering process.

### (5) Effects

In the method filtering apparatus 1 according to the present embodiment, the element information unique to each device element included in the analysis device 40 is acquired by the device information acquirer A from the analysis device 40. The method file information relating to a plurality of method files and the device specifying information for specifying the analysis device that is compatible with each method file are acquired by the provision system information acquirer C from the provision system 2. Based on the acquired element information, the acquired method file information and the acquired device specifying information, one or more method files that are usable in the analysis device 40 are determined by the determiner D from among the plurality of method files provided by the provision system 2. The result of determination is output by the outputter I.

With this configuration, even when a device element of the analysis device 40 is changed, the method file that is usable in the analysis device 40, the device element of which has been changed, is determined based on the device specifying information. Therefore, even when not being skilled at handling the analysis device 40, the user can easily identify the method file that is usable in the analysis device 40 by viewing the result of determination. Thus, a method file that is usable in any analysis device 40 can be easily acquired. Further, the user can easily identify how the functions of the analysis device 40 can expand by identifying the method file that is usable in the analysis device 40.

### (6) Other Embodiments

(a) While the method filtering apparatus 1 is provided separately from the online method store 30 and the analysis device 40 in the above-mentioned embodiment, the present invention is not limited to this. The method filtering apparatus 1 may be provided integrally with the online method store 30, or may be provided integrally with the analysis device 40.

(b) While the method filtering system 100 includes both of the database storage device 20 and the online method store 30 in the above-mentioned embodiment, the present invention is not limited to this. The method filtering system 100 does not have to include one of the database storage device 20 and the online method store 30. When the method filtering system 100 does not include the online method store 30, the process device 10 does not have to include the communication unit 18.

(c) While the outputter I includes both of the storage controller E and the display controller F in the above-mentioned embodiment, the present invention is not limited to this. The outputter I does not have to include one of the storage controller E and the display controller F. Alternatively, when the processing device 10 is connected to a print device, and a result of determination is output by the outputter I to the print device, the outputter I does not have to include both of the storage controller E and the display controller F. In this case, the result of determination is printed on a paper surface by the print device.

(d) While the method filtering apparatus 1 is configured to be capable of acquiring (including purchasing or downloading) a method file in the above-mentioned embodiment, the present invention is not limited to this. The method filtering apparatus 1 does not have to be configured to be capable of acquiring a method file. In this case, the method filtering apparatus 1 does not include the file requester G or the file acquirer H.

(e) While the method filtering apparatus 1 requests the provision system 2 for the method file information and the device specifying information based on an instruction given by the user in the above-mentioned embodiment, the present invention is not limited to this. The method filtering apparatus 1 may automatically request the provision system 2 for the method file information and the device specifying information at a predetermined time such as the time of activation of the method filtering apparatus 1.

(f) While the device specifying information includes the fixture information in the above-mentioned embodiment, the present invention is not limited to this. The device specifying information does not have to include the fixture information.

1. A method filtering apparatus that determines a method file that is usable in a predetermined analysis device from among a plurality of method files provided by a provision system,
an analysis device comprising a plurality of device elements and being configured to be capable of changing the device elements, and
the method filtering apparatus comprising:
a device information acquirer that acquires element information relating to the device elements from the analysis device;
a provision system information acquirer that acquires method file information relating to the plurality of method files and device specifying information for specifying an analysis device that is compatible with each method file from the provision system;
a determiner that determines a method file that is usable in the analysis device from among the plurality of method files provided by the provision system based on the element information acquired by the device information acquirer, and the method file information and the device specifying information acquired by the provision system information acquirer; and
an outputter that outputs a result of determination by the determiner.

2. The method filtering apparatus according to claim 1, further comprising:
a file requester that, based on an instruction given by a user, requests the provision system for any method file from among one or more method files that have been determined by the determiner as being usable in the analysis device; and
a file acquirer that acquires the method file requested by the file requester from the provision system.

3. The method filtering apparatus according to claim 1, wherein
device specifying information further includes fixture information indicating types of reagents, expendables or accessory devices to be used at a time of execution of each method file, and
the outputter, based on the fixture information, further outputs information about the types of the reagents, expendables or accessory devices to be used at the time of execution of each method file that has been determined by the determiner as being usable in the analysis device.

4. The method filtering apparatus according to claim 3, wherein the fixture information further includes information indicating countries of origin of the reagents, expendables or accessory devices, and
the outputter, based on the fixture information, further outputs the information about the countries of origin of the reagents, expendables or accessory devices to be used at the time of execution of each method file that has been determined by the determiner as being compatible with the analysis device.

5. The method filtering apparatus according to claim 1, wherein the outputter includes a display controller that allows a display unit to display a result of determination by the determiner.

6. The method filtering apparatus according to claim 1, wherein the outputter includes a storage controller that allows a storage to store a result of determination by the determiner.

7. A method filtering system comprising:
an analysis device that includes a plurality of device elements and is configured to be capable of changing the device elements;
a provision system that provides a plurality of method files and provides device specifying information for specifying an analysis device that is compatible with each method file; and
the method filtering apparatus according to claim 1 that determines a method file that is usable in the analysis device from among the plurality of method files provided by the provision system.

8. A method filtering procedure for determining a method file that is usable in a predetermined analysis device from among a plurality of method files provided by a provision system,
an analysis device comprising a plurality of device elements and being configured to be capable of changing the device elements; and
the method filtering procedure comprising:
acquiring element information relating to the device elements from the analysis device;
acquiring method file information relating to the plurality of method files and device specifying information for specifying an analysis device that is compatible with each method file from the provision system;
determining a method file that is usable in the analysis device from among the plurality of method files provided by the provision system based on the acquired element information, the acquired method file information and the acquired device specifying information; and
outputting a result of determination.
